(19) United States
(12) Patent Application Publication
(10) Pub. No.: US 2008/0284104 A1
(43) Pub. Date: Nov. 20, 2008

(54) CHEMISTRY CARD GAME

(75) Inventor: Anshul Samar, Cupertino, CA (US)

Correspondence Address: PARK, VAUGHAN & FLEMING LLP, 2820 FIFTH STREET, DAVIS, CA, 95618-7759, US

(73) Assignee: Anshul Samar, Cupertino, CA (US)

(21) Appl. No.: 12/121,488

(22) Filed: May 15, 2008

Related U.S. Application Data
(60) Provisional application No. 60/930,757, filed on May 17, 2007.
(60) Provisional application No. 61/053,476, filed on May 15, 2008.

(51) Int. Cl. A63F 1/00; G09B 19/22; G09B 23/24

(52) U.S. Cl. 273/302; 434/129; 434/298

(57) ABSTRACT

The present invention provides a novel method of game play and game components that in one embodiment are in the form of a board game with education cards which have actual information about the topic, along with game information such that learning becomes fun, and learning happens as a side effect of fun. In one version, the game components comprise chemistry element cards that attack with power based upon their oxidation state and move on the board based upon their physical state. In another version, these elements also have their real world reaction properties, but expressed in a form that applies to the game itself. In another version, the chemistry element cards can be combined and replaced by compound cards. In another version, there is another set of cards called as the Alchemy cards which impact the game from outside the battlefield. The game components may take other forms, such as electronic games, video games, computer games, and inter-active network. Similar ideas can be applied to many places to introduce different topics to kids and adults in the areas such as physics, history, math, biology, botany, zoology, army, music, human body, astronomy, and anthropology.

### RELATED APPLICATIONS

This application hereby claims priority under 35 U.S.C. §119(e) to U.S. Provisional Application Ser. No. 60/930,757, filed on 17 May 2007, the contents of which are herein incorporated by reference (Attorney Docket No. SAMAR07-1001PSP). This application also claims priority under 35 U.S.C. §119(e) to U.S. Provisional Application Ser. No. 61/053,476, filed on 15 May 2008, the contents of which are herein incorporated by reference (Attorney Docket No. SAMAR07-1002PSP).

### BACKGROUND

1. Field

The present invention pertains generally to games that combine education with fun, chance and strategy, and, more particularly, to a multi-participant chemistry card game that utilize the chemistry properties, and to a method of playing the game, as well as alternative embodiments of the same, including different game formats such as electronic games, interactive networks, computer software, board games, and role playing games.

2. Related Art

Trading cards are a well-known method of disbursing and collecting information about public figures. Trading cards have also been developed in areas such as baseball players, the music performers, television, and movie personalities. They are typically collector's items and while interesting, not much can be done with them.

Many games that are played with the more common face cards are games of chance, with perhaps lot of fun and excitement, but not much education or learning.

Many educational games have lot of education but not much fun and hence not many kids play with them.

At the present, there are no known games that combine fun with education in a very deep way such that learning is truly a side effect of playing.

The prior art relating to playing cards and card games discloses a wide variety of games as well as the types of cards used to play them. A description of several such games is provided by Hennessey (U.S. Pat. No. 6,017,034). The most well known of these are the card games played using the so-called “standard” playing card deck of 52 cards, wherein the generic nature of the deck allows it to be used in the play of many different games, each having different rules.

More recently, a new genre of fantasy card game has appeared wherein the cards held by one of the participants and selected from that participant's deck attempt to defeat the card characters held by the other participants that were selected from their respective decks using strategies and tactics in accord with the rules of the game. In general, the goal of each participant is to use the various powers of his cards to reduce the “energy” or “life” of the other participants. The “collectible” aspect of the cards used in these games derives from the advantages that accrue to the participant who possesses the cards with special powers, as well as the intrinsic artistic merit of the cards and their rarity. An example of this type of game is provided by Garfield (U.S. Pat. No. 5,662,332). For the purposes of drawing a clear distinction between the cards and method of play provided by the present invention and the method of the game taught by Garfield, it should be pointed out that Garfield provides a game of great complexity, utilizing many different types of cards, whose purposes are further varied according to their colors and which are brought into play by a designation process of first selecting from the initial set, and then “tapping,” in which the card is changed in its orientation. The game of Garfield does not provide a meaningful scientific learning experience, and is complex for most people.

A popular card game called “Magic,” produced by Wizards of the Coast, allows players to adopt fictitious roles for battle and treasure-finding purposes. The shortcoming of these games is that the roles that are played out are so removed from the actual experience of the players that there is very limited value of these games as tools for education and understanding.

It is a purpose of the present invention to provide a game that goes beyond the attributes of others in the prior art and is thereby rendered more suitable for a wider range of participants, particularly younger and much older participants. In particular, it is the purpose of the present invention to provide a game that not only differs from others in the prior art in terms of the nature and appearance of its cards, its rules, objectives, tactics, strategems, and general method of play, but also offers participants a multi-faceted learning and educational experience that is not provided by games known to the prior art.

Thus, a survey of the prior art reveals that no card game is adequately suited to fill the entertainment, communication, and education purposes envisioned. Thus, it would be necessary to conceive of and create a new, useful, and non-obvious card game that fills the need identified by the applicant.

There are also very few games that can be played by people of all ages and enjoyed.

While there have been a number of card games in area of history, English, baseball, and otherwise, but there have been no card games for Chemistry.

### SUMMARY

The present invention meets the need described above. It is a scientific and educational card game that combines learning with fun in an integrated and interesting manner such that kids do not even know that they are learning. This card game is designed to, not only be a source of entertainment, but also be a catalyst for learning.

The subject invention is comprised of playing cards which contain facts associated with the topic of the card. Each playing card may relate to subject matter such as but not limited to chemistry, physics, history, biology, botany, zoology, army, music, human body, astronomy, and anthropology.

Although the game indirectly teaches facts, it is not necessary that a particular player know anything about the facts that are being presented on the face of each playing card to win the game. Rather, education and awareness comes from the attention given by each player to those facts presented on the face of the card when battling using the facts on the cards.

In one form, the present invention is directed to a game for two or more players. The game components include rules of play and a plurality of game components that move on a playing surface or a game board using the educational or factual properties of the game elements. The game components also attack opponent's game components based upon their educational or factual properties. The game can also include articles or a method for tracking a counter such as game tokens or electrons assigned to each player so players know when game tokens or electrons have been reduced to zero, thereby defeating the player as per the rules of the game.

In accordance with another aspect of the present invention, the game cards are created out of the chemistry elements leveraging and using their chemistry properties. For example, the strength or the power of an element card is determined by its oxidation state/valence, and the direction of movement of the card on the game board or the playing surface is determined by the physical state of the card such as solid, liquid, or gas. Each card is represented by a fantasy figure that depicts how the element exists in the real world, and how is the element used. For each element card there is some optional text description that explains the story and character even further, and provides the reader some context, and as a side effect provides education and learning on that particular element card. As a result of this, even if the players do not know anything about that specific chemistry element or how is the element used in real world, they would learn about the element and how it is used because the game play uses different chemical and physical properties of the element for moving and battling with your opponent.

For example, when players see the helium card and note that helium moves in certain directions, it indicates to them that helium is a gas, and when they see that helium has no power, they realize that its oxidation state or valence electrons is zero. They also learn that it is a noble gas because that particular term is listed for its element family. This helps the players learn about chemistry while having fun and battling with their opponent.

In accordance with another aspect of the present invention, the elements also have unique properties and reaction powers that can be integrated with the game so that the players can learn about those. For example, since the helium gas element can be used for hot air balloons and carry people, that reaction power of the Helium may include the ability of Helium to carry another card two spaces on the playing surface. When the players are playing the game with the helium card, they automatically associate its ability to lift weight. This can also be reinforced through an appropriate illustration.

### BRIEF DESCRIPTION OF THE FIGURES

FIG. 1A presents an element card in accordance with an embodiment of the present invention.

FIG. 1B presents an element card with negative oxidation state in accordance with an embodiment of the present invention.

FIG. 1C presents an element card with reactions in accordance with an embodiment of the present invention.

FIG. 1D presents some possible movements for an element card in accordance with an embodiment of the present invention.

FIG. 1E presents a compound card in accordance with an embodiment of the present invention.

FIG. 1F presents an alchemy card in accordance with an embodiment of the present invention.

FIG. 1G presents a challenge card in accordance with an embodiment of the present invention.

FIG. 2 illustrates the layout of a playing surface for two opponents in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

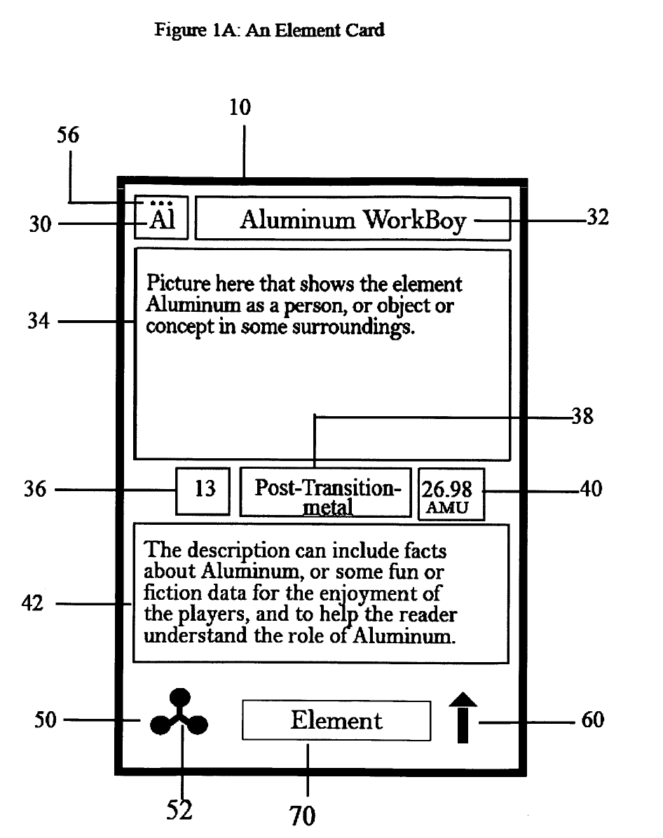

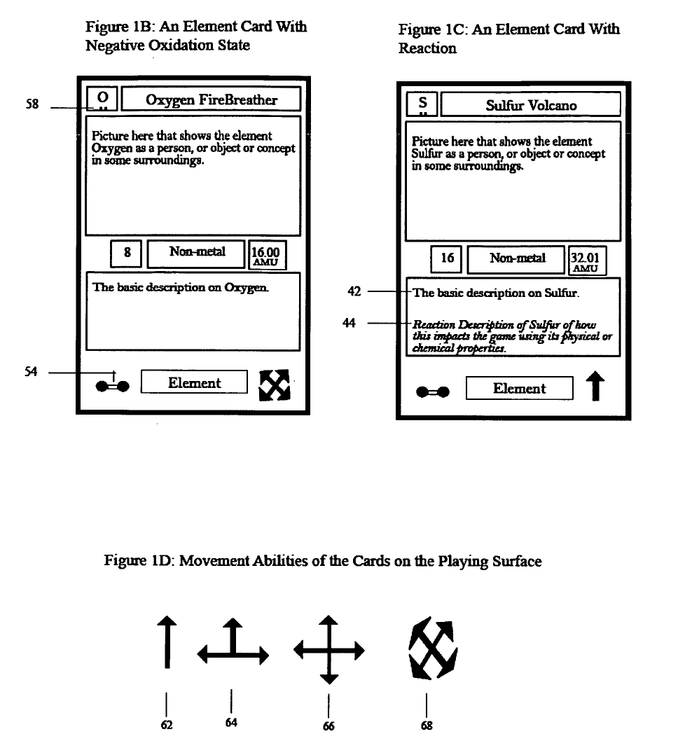

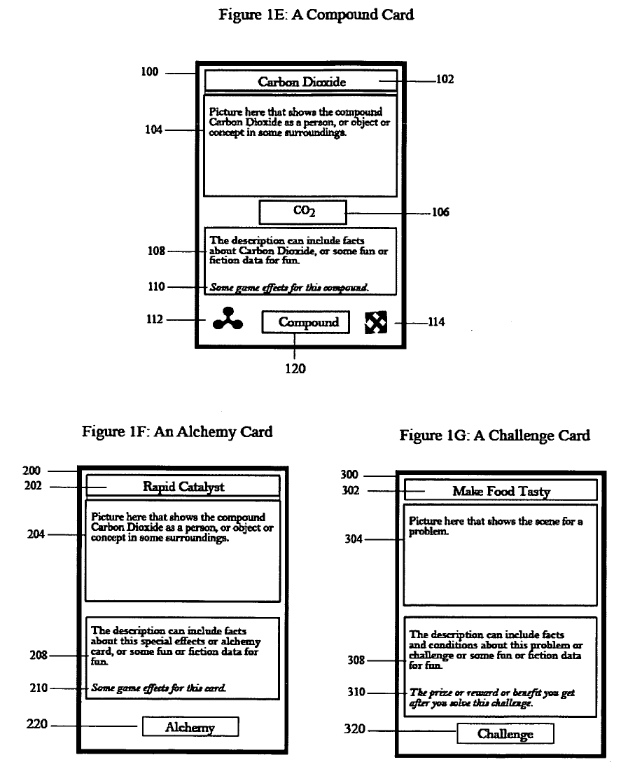

Referring initially to FIGS. 1A-1G, depicted therein are many types of cards available to players. Each of the cards are preferably constructed of sturdy card stock and having a playing face, some illustrations and associated indicia about some information of the card and about the effect of the card in the game. The opposite side of the card (not shown) contains the trade dress design that enables a player to know the type of the card, and who owns that deck for the duration of the game. Normally, the playing face is concealed from opposing players until the card is entered into play.

Referring to one such element card 10 in FIG. 1A, on the playing face 12 in the upper left-hand corner, there appears the element symbol 30 of the card. In the upper right-hand corner of the card is the name of the card 32. The illustration 34 provides a pictorial or graphic representation of the element card and how it exists in our world, whether real, or fictional. The illustration is not necessarily directly relevant to the playing of the game, but is provided more for the interest of the players, and to help the reader understand the role that this creature or person plays in the real world.

In the middle of the card 10 on the left side is indicia 36 indicating the atomic number of the element. In the middle of the card on the center is indicia 38 indicating the element family based upon the chemistry periodic table. In the middle of the card on the right side is indicia 40 indicating the atomic weight of the element shown in AMU (Atomic Mass Units). More such indicia could be added to indicate the chemical and physical properties such as melting point, boiling point, toxicity, and other such characteristics of the element.

The box below the indicia 36, 38, and 40 is the description box 42, which has the story behind the character or illustration 34. The description 42 may or may not be critical to the playing of the game. The description 42 can include facts about the element, or some fun or fiction data for the interest and enjoyment of the players, and to help the reader understand the role that this creature or person plays as an element in our world.

In the bottom left-hand corner of the card 10 is the power 50 of the card represented as spheres. This is also the “oxidation state.” The power can be represented using other means as well such as a different shape, pattern, color, dimension, number, etc. Depending upon the element's oxidation state, this can take values from zero or no spheres up to 6 or higher in some cases. If the elements have positive oxidation state, it is represented by spheres that are connected with solid lines 52, while if the elements have negative oxidation state, then they are presented by spheres connected with hollow lines 54 in FIG. 1B. The negative and positive oxidation states can be represented using other means as well such as color, pattern, and shade.

The oxidation state or the power 50 of the card 10 is also shown above and below the element symbol 30 based upon whether the oxidation state is positive or negative. If the elements have positive oxidation state, it is represented by dots 56 or some other indicia above the element symbol 30, while if the elements have negative oxidation state, then they are presented by dots 58 or some other indicia below the element symbol 30, in FIG. 1B.

The location and shape of these and other indicia is arbitrary and they could be placed anywhere on the card.

In the bottom right-hand corner of the card is the movement ability 60 of the card on the playing surface 500. This is also the “physical state” of the element at room temperature. In this case it is a “up” movement indicating that this is a hard solid.

Referring to the FIG. 1D, depending upon the physical state, this can have symbols to indicate whether the element in the card is hard solid 62 (upward movement symbol only), soft powder solid 64 (up, left, right movement), liquid 66 (up, down, left, right movement), or gas 68 (diagonal left-up, right-up, left-down, and right-down movement). The element card 10 can move in many directions on the play surface 500 based upon the movement ability 60. The movement symbol could as well be represented using some other means such as shape, color, shape, pattern, picture, etc.

Near the bottom of the card 10, the text 70 indicates the type of the card itself such as Element, Compound, Alchemy, etc. More such names could be added to indicate different types of cards. Here it says Element to indicate that this is an element card.

Referring back to the FIG. 1C, below the description 42 some cards have the text 44 in italics that describes the reaction of the card that typically shows how the physical or chemical property of the element is used in the game. This description is optional. The description 44 could have also been provided with some fictional data for the interest and enjoyment of the players. The text 44 could be in bold, a different font, a different color, or have other distinguishing characteristics to differentiate it from the regular description 42 just so that the players can easily locate it on the card.

The element description 42 and reaction description 44 can also be mixed up forcing the players to read the entire text and thus learn not just about the element's game property, but also how the element is used in the real world.

The reaction 44 can be used either in the player's own turn or can also be used for defense during the opponent's turn.

Referring next to FIG. 1E, the compound card 100 describes a compound card which is similar to the element card 10 but with a few differences. The compound card has its name 102 at the top of the card, and its chemical formula 104 in the center of the card. Just like the element card 10 has its illustrations, the illustration 104 provides a pictorial or graphic representation of the compound card 100 and how it exists in our world, whether real, or fictional. The illustration is not necessarily directly relevant to the playing of the game, but is provided more for the interest of the players, and to help the player understand the role that this creature or person plays in the real world. Under the illustration 104 is the chemical formula 106 for the compound indicating the elements needed to make the compound. Just like for elements, under the chemical formula 106 is the description box 108 which explains the story behind the character or illustration 104. Just like for elements, some compounds have the text 110 in italics that describe the reaction of the card that typically shows how the physical or chemical property of the compound is used in the game. This description is optional and it is not necessary to be there for all the cards. The description 108 and reaction description 110 can also be mixed up forcing the players to read the entire text and thus learn not just about the compound's game property, but also how the compound is used in the real world.

In the bottom left-hand corner of the compound card 100 is the power 112 of the card. The power can be shown as spheres or any other icon or just a number. In the bottom right-hand corner of the card is the movement ability 114 of the card. This is also the “physical state” of the compound at room temperature. In this case it is a gas that is shown with diagonal up-down-left-right movement symbol. Just like in the case of the element 10, the compound card 100 can move in many directions on the play surface 500 based upon the physical state of the compound at room temperature. Near the bottom of the card, the text 120 indicates that this is a compound card. The location and shape of these and other indicia is arbitrary and they could be placed anywhere on the card.

Referring next to FIG. 1F, the alchemy card 200 describes a card which has a name 202 and some description 208 along with reactions 210. Just like the element card 10 has its illustrations, the alchemy card 200 also has its illustration 204 that depicts its picture. Near the bottom of the card, the text 220 indicates that this is an alchemy card. The alchemy card 200 impacts the game from outside the play surface 500.

Referring next to FIG. 1G, the challenge card 300 describes a card which has a name 302 of the challenge or task. Just like the element card 10 has its illustrations, the challenge card 300 also has its illustration 304 that depicts its picture or challenge scenario. The description 308 describes the scenario, and impact 310 describes the benefit or advantage that the players get when they solve the challenge. Near the bottom of the card, the text 320 indicates that this is a challenge card.

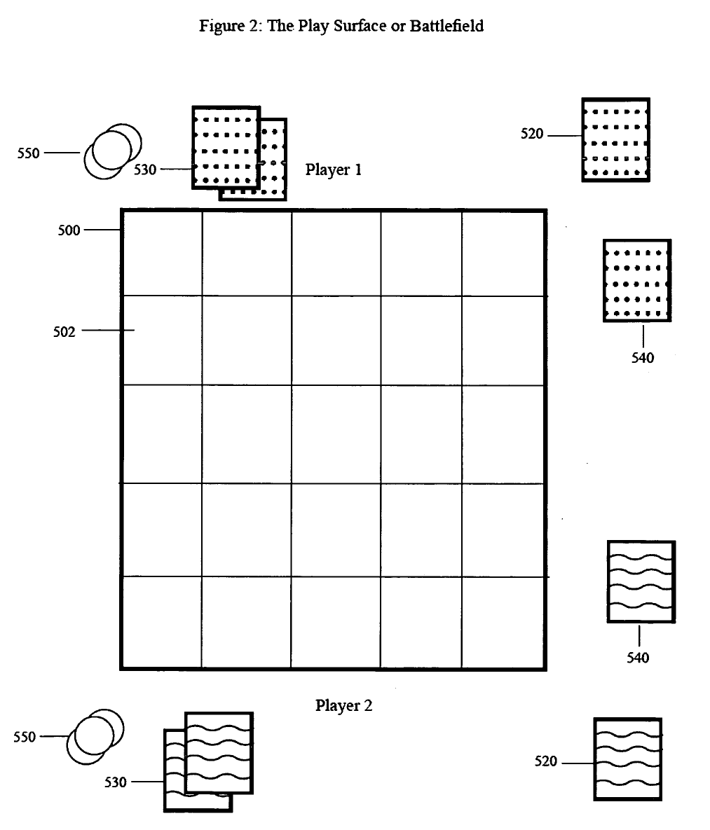

Referring next to FIG. 2, the play surface or the game board 500 has a rectangular playing surface defined by a matrix of block 502 arranged in rows and columns. The rectangle shape of the block 502 is not necessary to the playing of the game, and it could very well be a square, or a polygon with a variable number of side, or any other shape as well in accordance with the shape of the game component or the card.

FIG. 2 illustrates a representative playing surface 500 where one player is on one side, and the opponent player or team is on the other side. Each player also has a camp area 520 from which cards are drawn by players to be initially held in a player's hand 530 or moved to the player's side. After the cards are removed from play as per the rules of the game, they are discarded into what is called as the toxic waste pile 540 that is adjacent to the player, but it could be called something else and could be located somewhere else as well. Each player may begin the game with some predetermined number of game tokens 550.

It will be appreciated that variation to the embodiments above may be made without departing from the scope of the invention, for example, variation may include: (1) using a non-standard dice; (3) using a plurality of dice; (4) using a playing surface with different numbers of rows and columns; and (5) using different means to represent the power and the movement of the card, etc.

The invention described does not depend on any singular feature described above per say, but is an invention based on the particular combination of all of them disclosed and claimed and as distinguished in the combinations described hereafter. Though it has been described above, the more important features of the invention are such that the detailed description set forth below may be more easily understood, this summary of the invention is not meant to be all inclusive of the details of the game. There are, of course, additional features of the invention that will be described and which will form the subject matter of the claims appended hereto. Those skilled in the art of game design will appreciate that the conception, upon which this disclosure is based, might readily be utilized as a basis for the designing of other games, method structures, and systems for carrying out the purposes of the present invention. It is important, therefore, that the claims be regarded as including such equivalent constructions in so far as they do not depart from the spirit and scope of the present invention described.

Referring back to FIGS. 1A-1G, how the cards are brought into play and how the game is played will be described more fully below.

To summarize the embodiment presently being described, the chemistry card game can be seen to utilize one or more of different types of chemistry cards in the form of the element card 10, compound card 100, alchemy card 200, and challenge card 300.

In one form of the invention, a complete game set comprises a plurality of element cards alone with one set for each player. In another form of the invention, compound cards are also added to the game. In yet another form of the invention, alchemy cards are also added to the game. This entire collection of the element cards, rule book, game tokens, and playing surface is typically kept in a game-box or a container.

The game is generally played by each player obtaining an opening hand of a predetermined number of randomly selected cards from the camp area 520. The camp area 520 may be a common camp area shared by all players or preferably be an individual camp that consists of all the cards that are shipped with the game-box. Each player could also select specific cards from the collection of element cards based upon the overall game scenario. Each player's camp preferably consists of at least 15 cards to ensure an adequate mix of cards is present on which to draw on. The cards are placed face down in the camp 520 after being shuffled.

Once the cards are selected and placed in the camp area 520 of each player, the players then draw a predetermined number of cards randomly from it to form their opening hand 530. In a preferred embodiment, players draw seven cards. These cards remain in a player's hand and are kept from view of other players until placed in play.

To place an element card on the play surface 500, the players take the card from you're his/her hand, and put it face-up in an empty block on their first row on their side of the playing surface 500 or any other location as per the rules of the game.

Once on the playing surface, the cards can move one block 502 or any predetermined number of blocks at a time in the direction allowed as per its movement symbol 60. The card can move only into a neighboring empty block on the playing surface 500.

The player can attack an enemy card if it is blocking his/her card from moving forward, or if it in its line of sight or any other condition as per the rules of the game. In one embodiment, the player can attack an enemy card if it is blocking his/her card from moving forward in the direction of their movement.

To attack, the cards use their respective powers. The card with the higher power wins. If there is a tie, the card with the higher atomic number or any other distinguishing property such as higher melting point wins. The losing card goes face down to its toxic waste pile 540.

In one embodiment, the player attacks by rolling the dice and adding the number rolled to his/her card's power 50. This is their card's total power. The opponent also rolls the dice, and adds the number rolled to his/her card's power. That is his/her total power. The card with the higher total power wins. If there is a tie, the card with the higher atomic number wins.

In order to create further competitive gaming, in one embodiment of the invention, each player is assigned some predetermined number of game tokens such as 10 electrons. Tokens or counters may be used to track the electrons, or paper or other suitable calculation means may also be used. Various reactions, effects, or element or compound cards can provide additional electrons. Thus, a player's electrons will fluctuate during a game, and may go to zero. In one embodiment of the invention, the game may end in such a case.

In another embodiment of the invention, when a player's element card reaches a specific location such as the opponent's first row, the player's element card can destroy his/her opponent's electrons from there. In one preferred embodiment, the player rolls the dice to find the number of electrons he/she can destroy. For example, if he rolls a 2, he destroys 2 electrons. In another embodiment, the player's element cards can also use some other chemical or physical property to determine the number of electrons they can destroy. After destroying the electrons, the card then goes face-down to the player's toxic waste pile and joins other unused and destroyed cards. When a player destroys all opponent's electrons, the player wins the game. When all the cards are destroyed, the winner is determined by who has the most number of electrons left.

The players take alternate turns to play their cards. During every turn the players get to do a predetermined number of actions including placing and moving one or more of the element cards on the playing surface 500, and attacking the other player's element cards. The player can place you're his/her element cards on the first row, move them as per their allowed movements, and attack opponent's elements. When your cards reach opponent's first row or some predetermined location on the playing surface 500 as per the rules, they can destroy opponent's electrons as described earlier.

In one embodiment, the players get 3 actions per turn in which they can place, move, attack, and destroy electrons. The players alternate and continue to take 3 actions per turn until one side loses all its electrons, or has no cards left in hand and on the playing surface.

The element card 10 illustrated in FIG. 1C enables a player to temporarily or permanently introduce some effects or reactions 44 based upon the chemical or the physical property of the element itself in the real world. The reactions of the card enable a player to modify not only the card's power, movement, destroying ability, attacking ability, etc., but also the fundamental rules of play in many different ways including but not limited to: (1) Increase or decrease the power 50 of a card; (2) Change the mobility property 60 of a card; (3) Change the location of a card on the playing surface 500; (4) Change the number of spaces of blocks by which a card can move; (4) Destroy one or more opponent cards with or without any other conditions; (5) Destroy one or more opponent cards in a certain location of the playing surface; (6) Get or destroy game tokens; or (7) Change the number of actions per turn, or get extra turns or miss turns

There can be different properties of these effects: use once, use multiple times, use during player's turn, use during the opponent's turn, use anytime, continuous effects, etc.

When a player announces an attack, the opponent may initially respond with reactions from element or compounds cards or from alchemy cards. The attacking player may also respond with reactions from element or compounds cards or from alchemy cards.

In another embodiment of the invention, the players can combine element cards and replace them with compound cards. Once the compound is made, those element cards are sent to the player's toxic waste pile.

The compound formula 106 in the middle of the compound card 100 shows the symbols of the elements needed to create the compound. The element symbol 30 can be found on the top-left of the element card 10.

Some elements in a compound formula have numbers after them (such as the number 2 in CO2) indicating the number of atoms of that element that are needed to create the compound in real-life. For convenience in this game, each element card represents multiples of its own type. Thus, you need only 1 Carbon and 1 Oxygen card to create CO2.

The player can also create compounds by using one or more of you're his/her opponent's elements on the playing surface or the battlefield. In the preferred embodiment, the player gives some predetermined number of electrons to the opponent if opponent's element cards are used to make compounds. Compounds move and attack the same way as elements.

In one embodiment, the act of making a compound counts as one action.

As previously indicated, effects are also provided by special cards called alchemy cards. During the beginning of the game, each player gets or draws a predetermined number of alchemy cards from the game-box. During a player's turn, an alchemy card 200 can be activated by placing it outside the playing surface 500. Typically, the effect of an alchemy card stays only till the end of that turn, after which they are destroyed. Players use alchemy cards to attack opposing players' cards, modify the effect of other alchemy cards, or the rules of play, or alter the state of any card or any player, amongst other effects.

In one embodiment, the act of using an alchemy card counts as one action.

As previously indicated, players can also get challenges in form of a random set of challenge cards, each of which describes a challenge or a problem to be solved. Solving each challenge requires the players to create a compound or to get a specific element, and solving the challenge gives the player certain advantage such as extra electrons, or more actions, or more power.

In summary, one method of playing the game for each player comprises the steps of obtaining an opening hand of a predetermined number of element cards from the camp area 520; executing a turn to make compounds, enter into play element or compound cards to thereby attack, defend, and modify the effect of other cards, and the rules of play to thereby deal damage to opposing player to achieve the goal of defeating the opposing player.

In each turn, each player can take a predetermined number of actions. An action is not limited to one of the following but can include: (1) Place an element or compound card on the play surface from their hand to play; (2) Move an element or compound card on the play surface. (3) Draw a card from the top of the camp area and put it in the player's hand. (4) Attack an opponent card with a chosen card. The winner is determined by a variety of methods including the card's power optionally in combination with the outcome of the roll of a dice. The losing card is then removed from play and moved to the toxic waste pile. (5) Activate reactions and effects from element, compound, or alchemy cards. (6) Destroy electrons once the cards reach a certain location on the playing surface. (7) Make compound cards using rules as described earlier. (8) Solve a challenge.

In one embodiment, a player needs to give an opponent a chance to defend the attack.

In one embodiment of the invention, if an opponent's electrons reach zero, he/she loses the game.

While the foregoing provides a description of one embodiment of the game components and methods of play, various changes and enhancements may be made without departing from the spirit and scope of the invention.

Other changes and modifications may be made that still fall within the scope and spirit of the present invention. A number of these are described in the publication entitled Elementeo RuleBook which appears in U.S. Provisional Patent Applications No. 61/053,476 filed 15 May 2008, which is hereby incorporated by reference.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method of playing a chemistry card game for two or more players, the game involving rules of play and a set of element cards, the method comprising:
each player drawing a plurality of element cards for the player's hand from the given set;
each player executing turns by placing and/or moving one or more of the player's element cards on a playing surface, so that the one or more placed or moved element cards interact another player's element cards, wherein element cards interact according to rules derived from chemical properties of elements associated with the element cards.

2. The method of claim 1, wherein while executing a turn, each player:
selects one or more said element cards from his/her hand and places them on the playing surface, and
uses element cards belonging to the player on the playing surface to attack the element cards from the opponent player.

3. The method of claim 1, wherein the element cards have indicia including one or more of the element's name, symbol, oxidation state, physical state, atomic number, atomic weight, melting point, boiling point, safety characteristics, and element family for use in conjunction with the said game.

4. The method of claim 1, wherein the play surface is a matrix and the said element cards have an indicia to indicate how the card moves on the playing surface including forward, diagonal, sideways, or backwards based upon some property of the element.

5. The method of claim 1, wherein the each element card has an associated reaction property expressed as an indicia or descriptive text that influences the game in some way such as increasing the attack or the defense powers, or destroying the opponent, or changing the game in some way.

6. The method of claim 1, wherein when one of the element cards is used to attack one or more of the opponent's element cards, the winner is determined by one of the factual properties of the element card such as the element card's oxidation state, valence, power, strength, atomic number, atomic weight, boiling point, or melting point.

7. The method of claim 6, wherein the winner is determined by the roll of a dice or some random occurrence with or without further considering the factual properties of the element.

8. The method of claim 1, wherein a first player's element cards can attack an opponent's element cards only when the opponent's element cards are neighboring the first player's element cards or blocking the movement of the first player's element cards, or in line of sight, or line of action, or any such combination.

9. The method of claim 1, wherein the element cards are in electronic, paper, plastic, or any such media, and in any shape, size, language, or design.

10. The method of claim 1, wherein drawing element cards comprises first shuffling or mixing the element cards to get random element cards for the play.

11. The method of claim 1, wherein drawing element cards comprises all the players drawing from the same collection of element cards.

12. The method of claim 1, wherein drawing element cards comprises the players selecting specific element cards from the entire collection.

13. The method of claim 1,
wherein playing the game also involves using one or more chemical compound cards that can be brought to the playing surface, the chemical compound cards having indicia including but not limited to one or more of the compound's name, chemical formula, molecular weight, melting point, boiling point, power, strength, moving ability, and compound safety characteristics for use in conjunction with the game; and
wherein executing a turn involves using one or more compound cards in accordance with the indicia on the compound cards and the rules of play.

14. The method of claim 13, wherein using a compound card involves:
determining the element cards that are needed to make the compound card in the game based upon the indicia of the compound card;
locating those element cards on the playing surface or in the hand of a player;
exchanging the located element cards for the compound card; and
placing the compound card on the playing surface or in the hand of the player or adding it to a player's set of drawable cards.

15. The method of claim 14, wherein while making said compound card, if it takes more than one of the same basic element card, the same element card can be assumed to represent multiple copies of the same element at no cost or on payment of some game token.

16. The method of claim 13, wherein the said compound cards move on the playing surface based upon a moving ability of the said compound card.

17. The method of claim 14, wherein to make the compound card, the player can defragment or decompose one or more of the existing compound cards on the playing surface or the hand into element cards, and use the resulting element cards in making the compound cards.”

18. The method of claim 13, wherein to make compounds, a player has to pay in terms of one or more of game tokens or some such disadvantage.

19. The method of claim 13, wherein the players use their one or more of element or compound cards to solve a specific problem by making a specific compound to get more game tokens or some other advantage in the said game.

20. An apparatus that facilitates playing a chemistry card game for two or more players, the apparatus comprising:
a set of element cards;
a playing surface; and
rules of play, wherein the rules of play specify that the game is played by,
each player drawing a plurality of element cards for the player's hand from the given set;
each player executing turns by placing and/or moving one or more of the player's element cards on a playing surface, so that the one or more placed or moved element cards interact another player's element cards, wherein element cards interact according to rules derived from chemical properties of the elements associated with the element cards.

21. The apparatus of claim 20, wherein the apparatus is implemented on a computer system, and wherein the set of element cards and the playing surface are represented within a computer program which executes on the computer system.

23. A computer-readable storage medium storing instructions that when executed by a computer cause the computer to perform a method for playing a chemistry card game for two or more players, the game involving rules of play and a set of element cards, the method comprising:
each player drawing a plurality of element cards for the player's hand from the given set;
each player executing turns by placing and/or moving one or more of the player's element cards on a playing surface, so that the one or more placed or moved element cards interact another player's element cards, wherein element cards interact according to rules derived from chemical properties of the elements associated with the element cards.
